(19) United States
(12) Patent Application Publication
(10) Pub. No.: US 2010/0094936 A1
(43) Pub. Date: Apr. 15, 2010

(54) Dynamic Layering of an Object

(75) Inventors: Hannu Antero Simonen, Oulu (FI); Heli Johanna Musikka, Tyrnava (FI)

Correspondence Address: DITTHAVONG MORI & STEINER, P.C., 918 Prince Street, Alexandria, VA, 22314, US

(73) Assignee: NOKIA CORPORATION, Espoo (FI)

(21) Appl. No.: 12/251,554

(22) Filed: Oct. 15, 2008

(51) Int. Cl. G06F 15/16

(52) U.S. Cl. 709/204

(57) ABSTRACT

A computing device may associate data with a baseline content object. The data may be associated with a triggering-condition. The triggering condition may also be specified in the data. Upon a determination that the triggering-condition has occurred, the baseline content object may be modified as identified in the data. For example, the data may indicate to impose an image on another at a specific location, e.g., to place sunglasses on a picture of a user, when the user is “away.” Content objects may also include audio, video, and other content types. Triggering conditions may be based at least in part on user status, user preferences, news events, or any other user-based and/or external factor. The baseline content object or the modified version of the baseline content object may be communicated to one or more devices.

### FIELD

Aspects of the invention generally relate to computer networking. More specifically, an apparatus, method and system are described that impose a contextual modification to a content object, e.g., an image.

### BACKGROUND

Improvements in computing technologies have changed the way people accomplish various tasks. For example, some estimates indicate that between the years 1996 and 2007, the fraction of the world's population that uses the Internet grew from approximately 1% to approximately 22%. Irrespective of the actual percentages, trends suggest that the Internet will continue to grow.

Along with the growth of the Internet, users and service providers have developed numerous applications and corresponding interfaces to facilitate the exchange of information. For example, a husband and wife may be on vacation, and the wife may take pictures of the husband while the couple is at the beach using a digital camera. A first photo may show the husband sitting in a beach chair squinting due to the bright sunshine. A second photo may represent a slight variation of the first photo. For example, the husband may have put on his sunglasses to shield his eyes from the sun, and that may be the only substantial difference between the first photo and the second photo. The husband may want to share the photos with his friends over a social networking service, such as FACEBOOK. As such, using conventional techniques the husband would upload both the first and second photos to his user account, and his friends would look at his corresponding user profile to see the first and second photos.

The above example of the husband at the beach related to subtle differences between two photos. In actual practice, the husband may have taken multiple photos, each successive photo representing only a slight variation of a prior photo. It is time consuming for the man to take so many photos, thus depriving him of engaging in other fun activities at the beach, such as surfing. Furthermore, because the digital camera has a finite storage capacity (e.g., memory) associated with it, the couple may miss out on taking photos of different subject matter while on vacation due to filling up the memory with photos that are virtual replicas. When the couple gets home from vacation, the husband will have to engage in a time-consuming process to upload each of the photos to the social networking service. From the perspective of the social networking service, the upload operation consumes valuable bandwidth, and the storage of largely duplicative photos imposes increased costs in terms of allocated storage space (e.g., server memory) required.

### BRIEF SUMMARY

The following presents a simplified summary of aspects of the invention in order to provide a basic understanding of some aspects of the invention. This summary is not an extensive overview, and is not intended to identify key or critical elements or to delineate the scope of the claims. The following summary merely presents some concepts and aspects in a simplified form as a prelude to the more detailed description provided below.

To overcome limitations in the prior art described above, and to overcome other limitations that will be apparent upon reading and understanding the present specification, aspects of the present disclosure are directed to an apparatus, method and system for modifying a content object, e.g., an image, based at least in part on context.

Various aspects of the disclosure may, alone or in combination with each other, relate to imposing one or more layers on an uploaded content object. Other various aspects may relate to communicating the content object to one or more peer devices and communicating notifications of a change to a baseline of the content object.

These and other aspects of the invention generally relate to associating metadata with a content object. The metadata may provide context to a baseline version of the content object. The content object and associated metadata may be uploaded to a service. One or more peer devices may communicate with the service to obtain access to the content object. A user of a peer device may be able to view the baseline version of the content object or a contextually modified version of it. The peer device may impose modifications to the baseline version of the content object or to the contextually modified version of it. Notifications of a change to a baseline version of the content object may be communicated to one or more devices.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network computing environment suitable for carrying out one or more illustrative aspects of the invention.

FIG. 2 illustrates a data processing architecture suitable for carrying out one or more illustrative aspects of the invention.

FIG. 3 illustrates an architecture suitable for practicing one or more aspects of the invention.

FIG. 4A illustrates a method suitable for uploading a content object in accordance with one or more aspects of the invention.

FIG. 4B illustrates a menu architecture suitable for demonstrating one or more aspects of the invention.

FIGS. 5A-5E illustrate a use case scenario demonstrating one or more aspects of the invention.

FIG. 6 illustrates an architecture suitable for practicing one or more aspects of the invention.

### DETAILED DESCRIPTION

In the following description of the various embodiments, reference is made to the accompanying drawings, which form a part hereof, and in which is shown by way of illustration various embodiments in which one or more aspects of the invention may be practiced. It is to be understood that other embodiments may be utilized and structural and functional modifications may be made without departing from the scope of the present invention.

Conventional sharing applications may require multiple content objects to be uploaded to a service, or more specifically, a user account. It may be possible to aggregate or group similar content objects. Providing for such groupings may be cumbersome for a limited number of content objects, let alone if there are a large number of content objects, or if the content objects are destined for multiple services or user accounts.

As demonstrated herein, a baseline version of a content object may be uploaded to a service. Metadata associated with the content object may allow the content object to take on a modified context relative to the baseline version. One or more users of peer devices may obtain the baseline version of the content object, one or more context modifications to the baseline version, and/or a wholly modified content object.

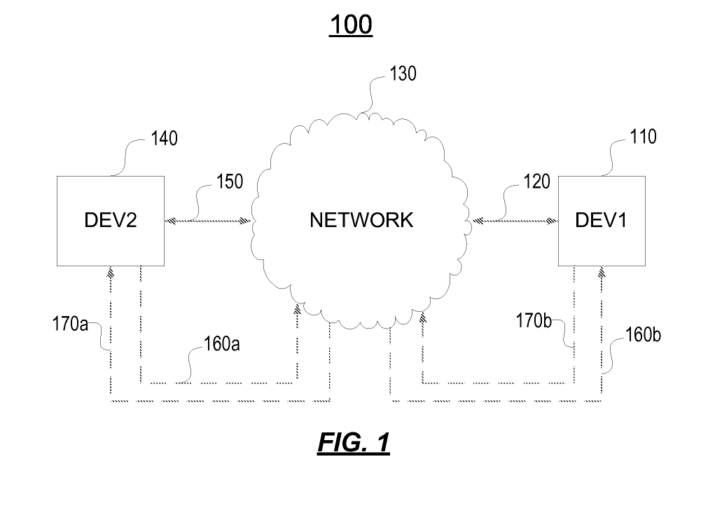

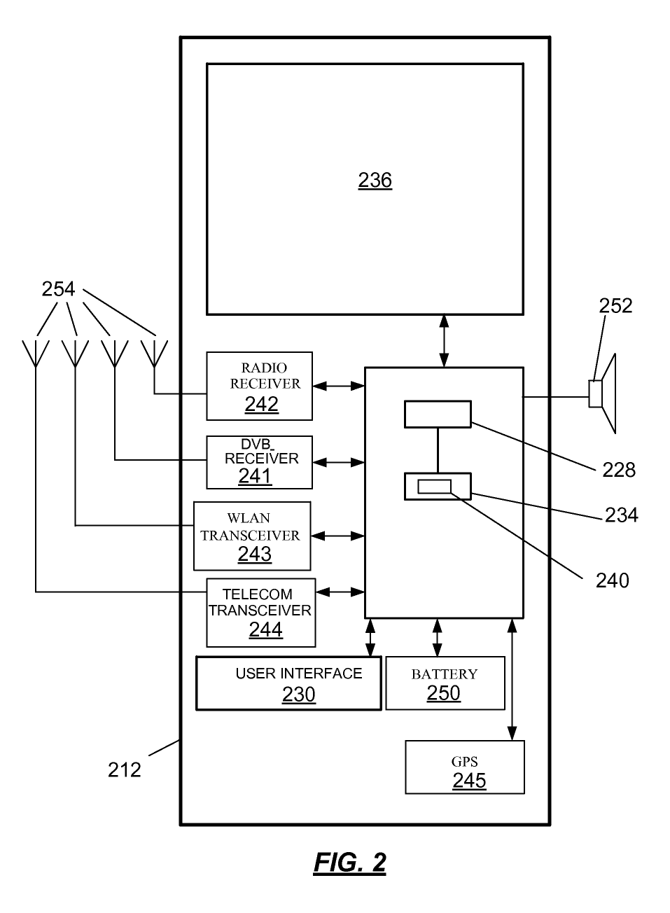

FIG. 1 illustrates a network computing environment 100 suitable for carrying out one or more aspects of the present invention. For example, FIG. 1 illustrates a first device DEV1 110 (e.g., device 212, FIG. 2) connected to a network 130 via a connection 120. Network 130 may include the Internet, an intranet, wired or wireless networks, or any other mechanism suitable for facilitating communication between computing platforms in general. FIG. 1 also depicts a second device DEV2 140 (e.g., a server) connected to network 130 via a connection 150. By virtue of the connectivity as shown, DEV1 110 and DEV2 140 may communicate with one another. Such communications may enable the exchange of various types of information. For example, the communications may include data to be exchanged between DEV1 110 and DEV2 140. Such data may include images, files, and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bidirectional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two devices. For example, DEV2 140 may exchange communications with a plurality of other devices (not shown) in addition to DEV1 110. The communications may be conducted using one or more communication protocols. Furthermore, computing environment 100 may include one or more intermediary nodes (not shown) that may buffer, store, or route communications between the various devices.

FIG. 2 illustrates a generic computing device 212, e.g., a desktop computer, laptop computer, notebook computer, network server, portable computing device, personal digital assistant, smart phone, mobile telephone, cellular telephone (cell phone), terminal, distributed computing network device, mobile media device, or any other device having the components or abilities to operate as described herein. As shown in FIG. 2, device 212 may include processor 228 connected to user interface 230, memory 234 and/or other storage, and display 236. Device 212 may also include battery 250, speaker 252 and antennas 254. User interface 230 may further include a keypad, touch screen, voice interface, four arrow keys, joy-stick, stylus, data glove, mouse, roller ball, touch screen, or the like. In addition, user interface 230 may include the entirety of or portion of display 236.

Computer executable instructions and data used by processor 228 and other components within device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling device 212 to perform various functions. Alternatively, some or all of the computer executable instructions may be embodied in hardware or firmware (not shown).

Furthermore, the computing device 212 may include additional hardware, software and/or firmware to support one or more aspects of the invention as described herein. Device 212 may be configured to receive, decode and process digital broadband broadcast transmissions that are based, for example, on the Digital Video Broadcast (DVB) standard, such as DVB-H, DVB-T or DVB-MHP, through a specific DVB receiver 241. Digital Audio Broadcasting/Digital Multimedia Broadcasting (DAB/DMB) may also be used to convey television, video, radio, and data. The mobile device may also include other types of receivers for digital broadband broadcast transmissions. Additionally, device 212 may also be configured to receive, decode and process transmissions through FM/AM Radio receiver 242, WLAN transceiver 243, and telecommunications transceiver 244. In at least one embodiment of the invention, device 212 may receive radio data stream (RDS) messages. Additionally, a global positioning system (GPS) module 245 or other location tracking equipment may be included in device 212, or device 212 may communicate with external location tracking equipment module.

Device 212 may use computer program product implementations including a series of computer instructions fixed either on a tangible medium, such as a computer readable storage medium (e.g., a diskette, CD-ROM, ROM, DVD, fixed disk, etc.) or transmittable to computer device 212, via a modem or other interface device, such as a communications adapter connected to a network over a medium, which is either tangible (e.g. optical or analog communication lines) or implemented wirelessly (e.g., microwave, infrared, radio, or other transmission techniques). The series of computer instructions may embody all or part of the functionality with respect to the computer system, and can be written in a number of programming languages for use with many different computer architectures and/or operating systems. The computer instructions may be stored in any memory device (e.g., memory 234), such as a semiconductor, magnetic, optical, or other memory device, and may be transmitted using any communications technology, such as optical infrared, microwave, or other transmission technology. The computer instructions may be operative on data that may be stored on the same computer readable medium as the computer instructions, or the data may be stored on a different computer readable medium. Moreover, the data may take on any form of organization, such as a data structure. Such a computer program product may be distributed as a removable storage medium with accompanying printed or electronic documentation (e.g. shrink wrapped software), preloaded with a computer system (e.g. on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

In at least one embodiment, device 212 may include, for example, a mobile client implemented in a C-based, Java-based, Python-based, Flash-based or any other programming language for the Nokia® S60/S40 platform, or in Linux for the Nokia® Internet Tablets, such as N800 and N810, and/or other implementations. Device 212 may communicate with one or more servers over Wi-Fi, GSM, 3G, or other types of wired and/or wireless connections. Mobile and non-mobile operating systems (OS) may be used, such as Windows Mobile®, Palm® OS, Windows Vista® and the like. Other mobile and non-mobile devices and/or operating systems may also be used.

By way of introduction, aspects of the disclosure may provide for uploading a baseline version of a content object to a service. Metadata may be associated with the content object. The content object may undergo a contextual modification based at least in part on the metadata.

The description provided below is in terms of modifications to an image. It is understood that the disclosure provided herein may be adapted to support any type of content object, such as an audio file, a video file, a text file, podcast file, multimedia file, electronic book and/or the like.

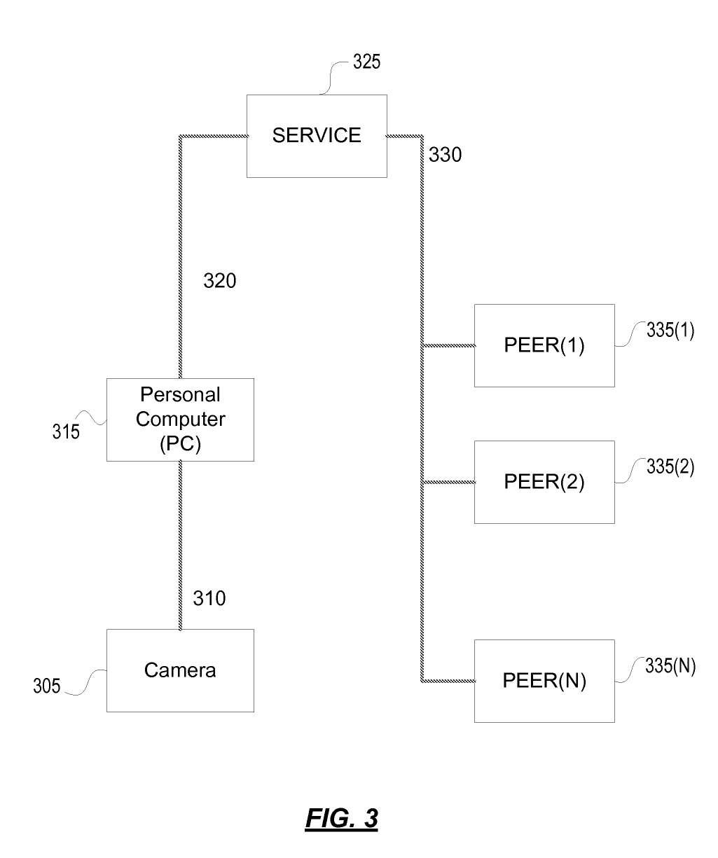

FIG. 3 depicts a computing architecture suitable for carrying out one or more aspects of the invention. As shown in FIG. 3, a camera 305 may be coupled to a personal computer (PC) 315 by way of a communication link 310. Communication link 310 may support a transfer of one or more images between camera 305 and PC 315. For example, images initially taken by camera 305 may be transferred to PC 315 via communication link 310. PC 315 may save in a memory of PC 315 one or more of the images received from camera 305.

As shown in FIG. 3, PC 315 is coupled to a service 325 by way of a communication link 320 (e.g., a computer network such as the Internet). Communication link 320 may support a transfer of one or more images between PC 315 and service 325. For example, PC 315 may upload the saved images from PC 315's memory to service 325. Service 325 may take the form of a personal server, a commercial server/service (e.g., OVI.COM), or the like. Service 325 may associate the uploaded images with one or more user accounts or the like.

As shown in FIG. 3, service 325 is coupled to a number (N) of peer devices 335(1)-335(N) by way of communication link 330. Communication link 330 may support a transfer of one or more images between service 325 and one or more of peer devices 335(1)-335(N). For example, one or more of peer devices 335(1)-335(N) may obtain from service 325 one or more of the images described above.

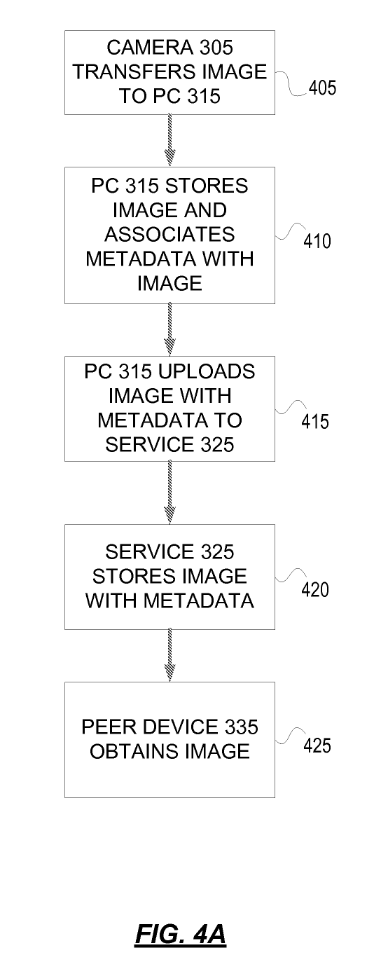

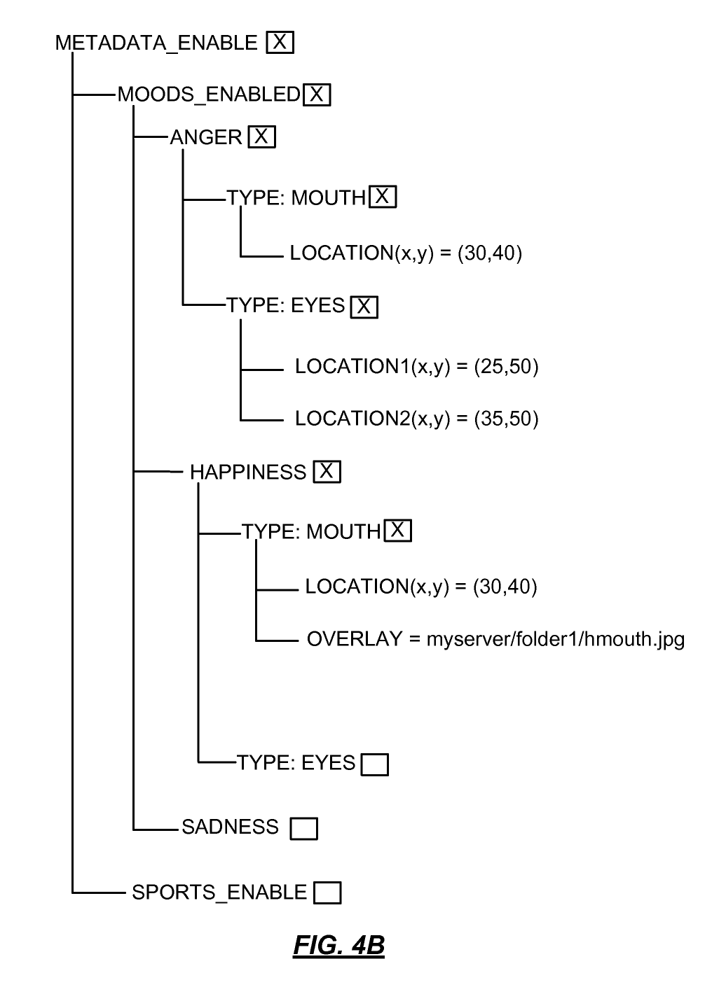

Based on the architecture of FIG. 3, one or more images may be transferred from a camera (e.g., camera 305) to one or more peer devices (e.g., peer devices 335(1)-335(N)). The intervening entities (e.g., PC 315 and service 325) may operate on the image along the communication path from camera 305 to peer devices 335(1)-335(N) as further described below with respect to FIG. 4.

The architecture of FIG. 3 is merely illustrative. In some embodiments, substitute computing devices may be used in place of camera 305, PC 315, service 325, and peer devices 335(1)-335(N). For example, a mobile device (e.g., device 212 of FIG. 2) may be used in place of PC 315. Service 325 and peer devices 335(1)-335(N) may take the form of one or more computing devices, including PCs, laptops, servers, mobile phones, mobile terminals and the like. Additional devices (not shown) may be included in some embodiments. For example, intermediary servers, routers and the like may facilitate communication between the various entities shown in FIG. 3. Moreover, in some embodiments, one or more of the devices may be combined into a single device. For example, PC 315 and service 325 may be combined in some embodiments. Additionally, in some embodiments, camera 305 and PC 315 may be combined, such as in a mobile device that includes a camera.

FIG. 4A illustrates a method wherein one or more illustrative aspects of the invention may be practiced. In particular, the method of FIG. 4A is described below based on the architecture discussed above in relation to FIG. 3. It is understood that the method of FIG. 4A may be adapted to accommodate modifications to the architecture of FIG. 3 without departing from the scope and spirit of the instant disclosure.

In step 405, camera 305 transfers an image to PC 315. For example, a user returning from a vacation may wish to download an image from a memory device associated with camera 305 to PC 315. A user may initiate the transfer of image from camera 305 to PC 315 using one or more menus, buttons or the like associated with either camera 305 or PC 315. Alternatively, the transfer of the image may be initiated automatically when camera 305 and PC 315 are coupled to one another via communication link 310. For example, communication link 310 may represent a wired-connection, and when the wired-connection is established, the transfer of the image may take place automatically. In some embodiments, communication link 310 may be a wireless connection that is established when a first of the devices (e.g., camera 305) senses that it is in proximate range of a second of the devices (e.g., PC 315).

In step 410, PC 315 may save the image received from camera 305 in step 405. PC 315 may also associate metadata with the saved image. In addition or instead, camera 305 may also associate metadata with the saved image. The metadata may provide context to the image. The metadata may be created or selected by a user associated or otherwise responsible for the image. For example, a user of PC 315 may be able to select fields from a menu or the like presented on PC 315. An example of such a menu is provided in FIG. 4B and will be described below.

With respect to FIG. 4B, a tree structure is presented that enables a user to select various fields for purposes of defining metadata to be associated with an image. A first field entitled “metadata_enable” and a corresponding selection box is demonstrated. The “metadata_enable” field, when selected, may be used to contextually modify the image in accordance with the other selections shown in FIG. 4B and described below. When the “metadata_enable” field is not selected (e.g., the selection box corresponding to “metadata_enable” does not have an ‘X’ inside of it), contextual modification might not be imposed on the image, but rather, only a baseline version of the image uploaded to service 325 may be visible to users.

Also shown in FIG. 4B is a “moods_enabled” field that has been selected. The “moods_enabled” field may operate in conjunction with a mood setting associated with a user profile (not shown) such that changing the mood setting on the user profile will cause a contextual modification to the image in accordance with the moods selected. In the example of FIG. 4B, the user has selected “anger” and “happiness” as moods for contextual modification of a baseline version of the image, and has decided to forego contextually modifying the baseline version of the image to display features related to “sadness.”

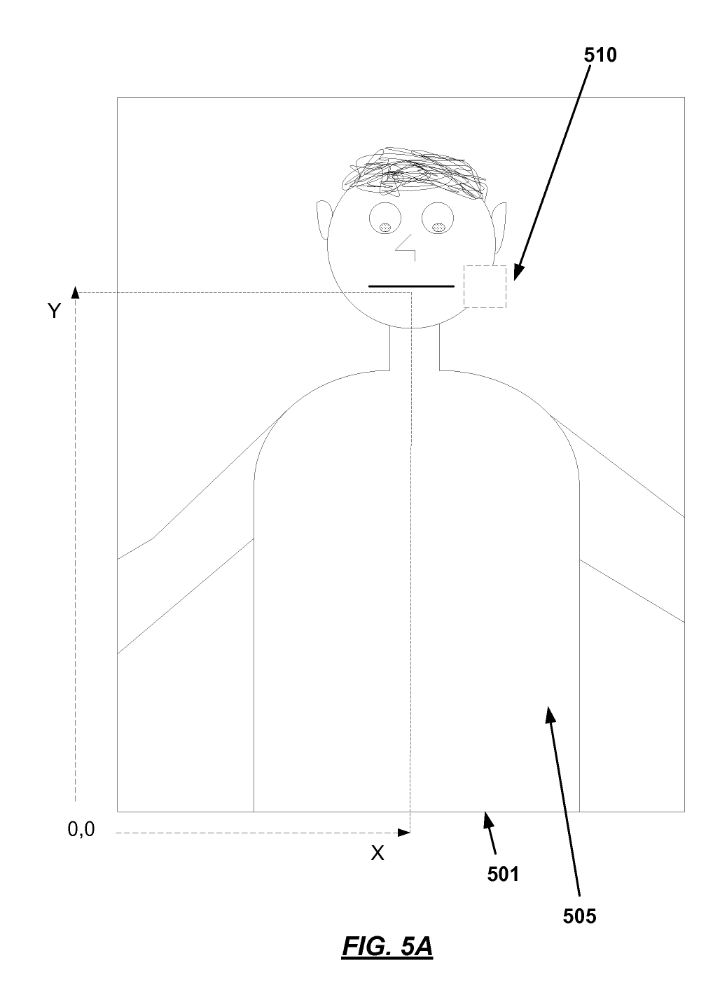

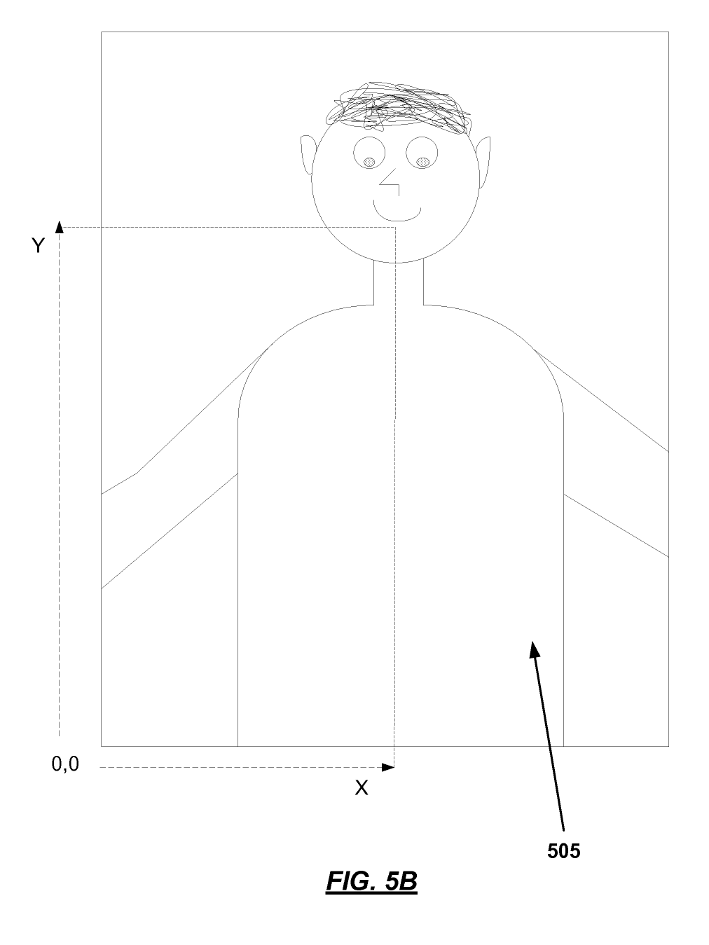

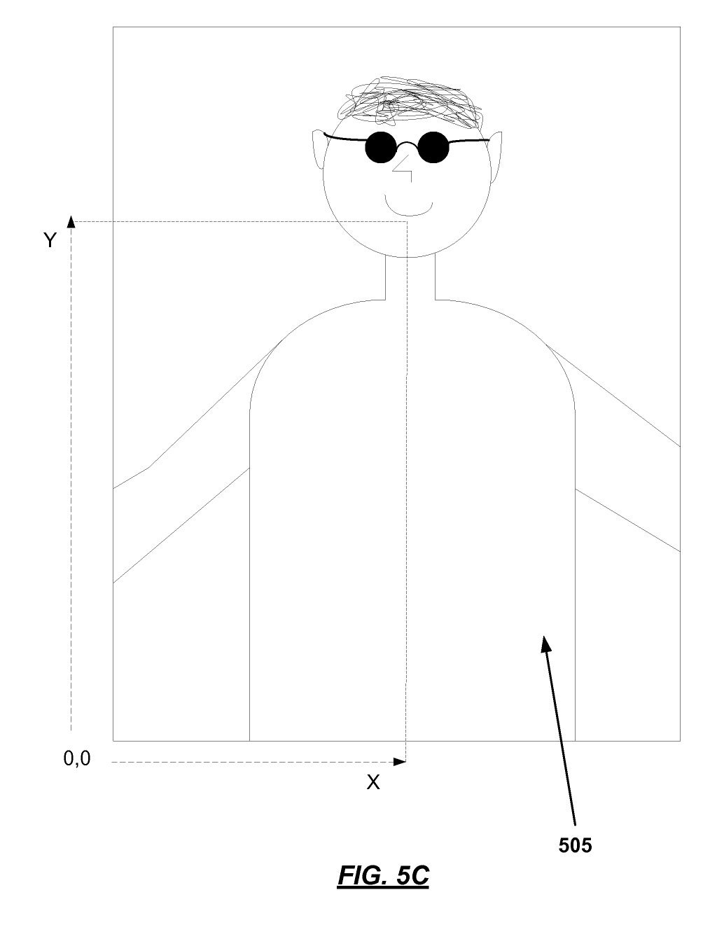

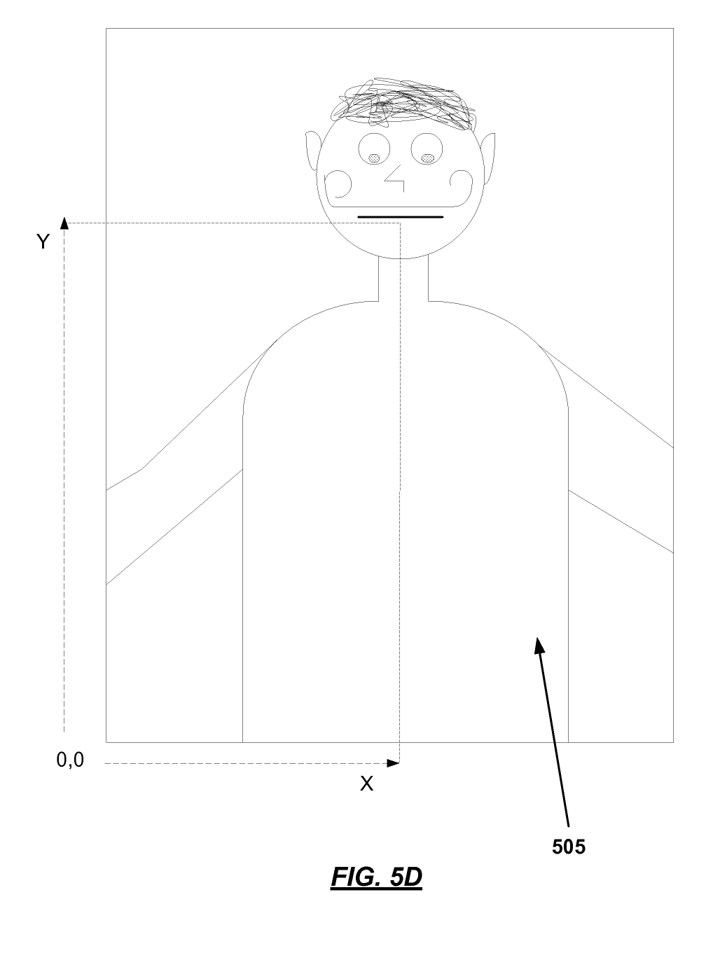

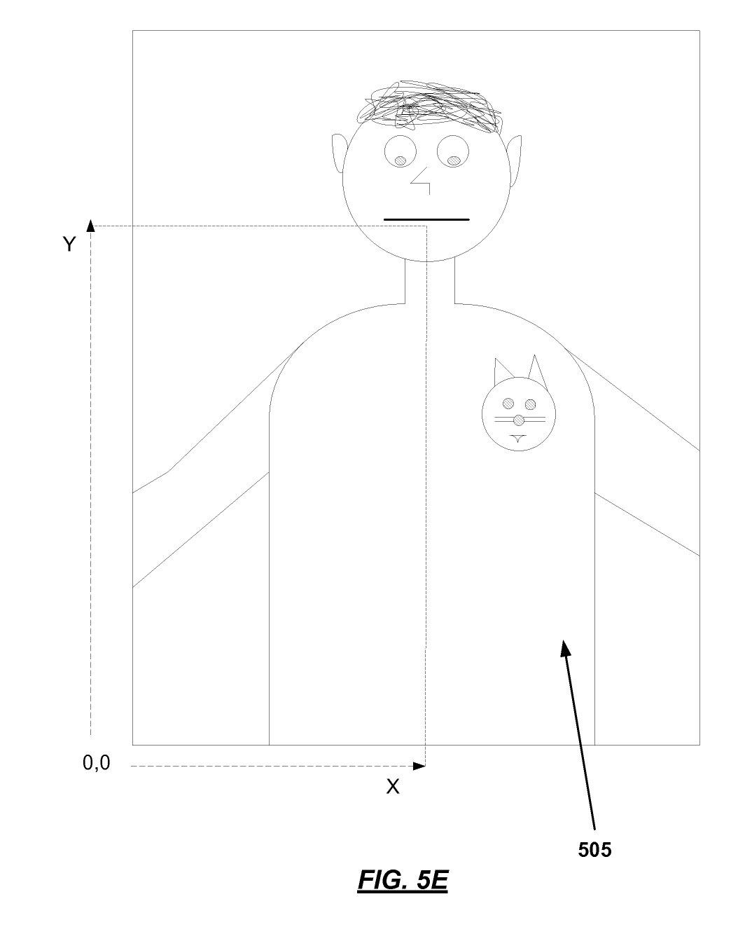

Regarding the selected “anger” field, type fields may be presented to the user in relation to how anger is to be portrayed based at least in part on contextual modification. In the example of FIG. 4B, the user has selected anger to be portrayed with respect to contextual modification of the “mouth” and the “eyes.” Furthermore, the user has defined a coordinate location (x,y) of the mouth to be at (30,40) relative to a (0,0) origin point of the image. Looking ahead to FIG. 5A, the (0,0) origin point may be defined as the lower left corner of the image and the center of the mouth may correspond to the defined location of (30,40). A small box 510 may temporarily be drawn on top of the image to assist a user in defining the coordinate location (x,y) of the mouth, and the user may be able to manipulate the coordinate points accordingly (by iteratively choosing the (x,y) values, or by clicking-dragging-dropping small box 510 over an approximate center of the mouth, for example). Similarly, as shown in FIG. 4B, the user may also define coordinate location (x,y) points, “location1” and “location2,” for the depicted person's right eye as (25,50) and the person's left eye as (35,50), respectively.

Regarding the selected “happiness” field, the user has elected to portray “happiness” via a contextual modification to the “mouth” but has decided to forego contextual modification to the “eyes.” The coordinate (x,y) location for the “mouth” type under the “happiness” field may be carried over from the selection made for the “mouth” type under the “anger” field. Another entry related to “overlay” may specify the location where to fetch an item to be overlaid on top of the baseline version of the mouth when a “happiness” mood is selected. As shown in FIG. 4B, the “overlay” field is assigned to a “myserver/folder1/hmouthjpg” file, which may serve to instruct service 325 to fetch a decal named “hmouth” from a server named “myserver,” in a folder location named “folder1.”

Based on FIG. 4B, a user may facilitate the creation of metadata that may be used to contextually modify a baseline version of an uploaded image. FIG. 4B includes an additional “sports_enable” field that has not been selected by the user. It is understood that additional fields may be implemented in practice, and the tree-structured menu of FIG. 4B is merely illustrative. That is, when a user does select the “sports_enable” field or any other check box, the tree may be automatically expanded to provide any available subfields.

Once a user has completed making selections in accordance with the menu of FIG. 4B, the user may select an “ok” button or the like to save the entries. Once the user confirms the selections, e.g., via depression of the “ok” button or the like, the selections may be saved as a metadata file or the like. The contents of the metadata file, based at least in part on the selections shown in FIG. 4B, may take the form of a metadata string similar to: “metadata_enable=true; moods_enabled=true; moods.anger=true; moods.anger.type_mouth=true; moods.anger.type_mouth.location=(30,40); moods.anger.type_eyes=true; moods.anger.type_eyes.location1=(25,50); moods.anger.type_eyes.location2=(35,50); moods.happiness=true; moods.happiness.type_mouth=true; moods.happiness.type_mouth.location=(30,40); moods.happines.overlay=myserver/folder1/hmouth.jpg; moods.happiness.type_eyes=false; moods.sadness=false; sports_enable=false”. Examples of how the metadata string is used or triggered are provided below with respect to the description of FIG. 5. Based at least in part on the metadata and any identified decals (e.g., graphical overlays), a receiving device (e.g., a peer device viewing the context image with associated metadata) can reconstruct the image in accordance with the metadata, taking into account any preferable preconditions defined by the metadata. For example, the metadata may further include conditional requirements, e.g., if a user associated with the baseline image is presently on vacation, then the “happiness” conditions may be automatically applied, regardless of what the user has selected. In addition, one or more data processing devices may perform automatic image recognition to create the metadata without user intervention. Still alternatively, the user may simply be requested to answer specific questions, e.g., favorite sports team, favorite vacation spot, etc., and PC 315 may generate the metadata automatically based at least in part on the user responses, providing context options for displaying the user wearing a shirt having his or her favorite sports team's logo, displaying the user with the background of the user's favorite vacation spot (e.g., beach), etc.

Referring back to FIG. 4A, in step 415, PC 315 uploads the image with the associated metadata to service 325. The image may be uploaded to a user account associated with a user of PC 315 and maintained by service 325. The image itself may be interpreted as a baseline version of the image as further described below with respect to FIG. 5. In short, a baseline version of an image represents an image that has not been subjected to a contextual modification. Similarly, the metadata may be interpreted as providing for a contextual modification to the baseline version of the image, also as further described below with respect to FIG. 5. In short, as it relates to an image, a contextual modification causes a modification to the baseline version of the image when a triggering condition has been satisfied. The triggering condition may be encoded or encapsulated via metadata similar to the metadata string described above in conjunction with FIG. 4B. The modification may include overlaying a second image over a portion of the baseline version of the image, or may include color modification, application of one or more image effects, or any other manipulation of the appearance of the baseline image. As such, all of the foregoing techniques related to a manipulation of the appearance of the baseline image may be associated with imposing an image layer over or otherwise with respect to a baseline version of an image.

In step 420, service 325 may store the uploaded image with the associated metadata. Service 325 may operate on the baseline version of the image in accordance with the associated metadata. For example, when an event such as a change to a user profile setting occurs, service 325 may determine that the event triggers a condition specified in the metadata such that service 325 subjects the baseline version of the image to a contextual modification. A contextually modified version of the baseline version of the image may be shared or communicated with one or more of peer devices 335 as described below with respect to step 425. Additional examples of contextual modification will be described below in relation to FIG. 5.

In step 425, one or more of peer devices 335 may obtain the image. More specifically, the peer devices 335 may obtain the contextually modified version of the image generated in step 420 from service 325. In some embodiments, the peer devices 335 may obtain both the baseline version of the image and the associated metadata, and the contextual modification may be performed at the peer devices 335, thereby precluding of a need to perform a contextual modification at service 325.

In some embodiments, peer devices 335 may also be able to trigger a contextual modification to the uploaded image. For example, a user of PC 315 may grant permission to one or more of peer devices 335 to engage in contextual modification of the image. An identification of peer device(s) 335 granted such permission may be included in the menu and metadata string described above in conjunction with FIG. 4B. As such, a peer device 335 granted such permission may supply metadata to service 325 (via communication link 330) to contextually modify the uploaded baseline image when trigger conditions specified in the metadata are satisfied.

There may be instances where the metadata submitted by PC 315 conflicts with metadata submitted by peer device(s) 335. For example, a user of PC 315 may indicate that he does not want a profile image to portray themes associated with a particular political party. Conversely, one or more of peer devices 335 may submit metadata to service 325 directing service 325 to contextually modify the profile image when a rally is held on behalf of the particular political party. If a conflict, such as the one just presented in relation to the particular political party exists between the metadata submitted by PC 315 and a peer device 335, one or more priority schemes may be used to resolve the conflict. For example, the metadata generated by PC 315 may be given priority because the image was uploaded by PC 315. Other priority or conflict resolution schemes may be used.

The method depicted in FIG. 4 is merely illustrative. It is understood that some of the steps shown may be optional, and that additional steps may be included without departing from the spirit and scope of the instant disclosure. For example, in some embodiments PC 315 might not upload the metadata with the image in step 415. Instead, PC 315 may provide the metadata to service 325 at a later point in time. Furthermore, PC 315 may update previously uploaded metadata, and the updated metadata may be used to supplement or replace previously uploaded metadata at service 325.

FIG. 5 illustrates a use case scenario suitable for demonstrating one or more example aspects of the instant disclosure. Specifically, FIG. 5A may represent a baseline version of an image 501 uploaded to service 325 in accordance with the architecture of FIG. 3 and the method of FIG. 4A. More specifically, image 501 may be associated with a profile picture or a user account. As shown in FIG. 5A, the image 501 depicts a person 505. In the baseline version of the image, person 505 has a first facial express, e.g., a moderate/okay disposition where person 505 is not smiling or frowning, but rather has a straight-line mouth. From the perspective of service 325, person 505's mouth may consume a portion of the overall image, with the mouth centered at coordinate pair (x,y) relative to origin (0,0) located at the lower left corner of the image. With respect to the example provided in FIG. 4B, the mouth was presumed to be centered on (x,y) pair (30,40), and as described above, small box 510 may be used to assist a user in determining an approximate center of the mouth.

In FIG. 5B, person 505 appears happy relative to his disposition in FIG. 5A, e.g., person 505 in FIG. 5B now has a “smiling” mouth. The change from FIG. 5A to FIG. 5B may be made, for example, in accordance with one or more “mood settings” associated with a user profile. For example, in reference to FIG. 3, a user of PC 315 (which may be the same person 505 depicted in FIG. 5) may have logged-on to his user account with service 325 and may have changed a “mood setting” from “moderate/okay” to “happiness.” Responsive to the change in “mood setting,” metadata associated with the image may contain a switch or the like, and may trigger a change from straight-line mouth to smiling mouth. More specifically, and in relation to the above description of the menu and metadata string of FIG. 4B, a comparison may take place between the moods.happiness entry in the metadata string to determine that contextual modification is to take place when the user changes his profile “mood setting” to “happiness” because the moods.happiness entry in the metadata string is set to ‘true’ in accordance with the corresponding selection from the menu depicted in FIG. 4B. Similarly, the moods.happiness.type mouth entry in the metadata string is set to ‘true’ and the location of the mouth in terms of (x,y) coordinates in the image is specified as (30,40) in accordance with the corresponding entry of moods.happiness.type_mouth.location in the metadata string. The smiling mouth may be overlaid on top of the baseline version of the straight-line mouth centered on (x,y) coordinates (30,40) in order to effectuate the visual appearance of a change in disposition.

The smiling mouth of FIG. 5B may be obtained from a library associated with service 325. Alternatively, the smiling mouth may be obtained from a location referenced by a menu similar to that shown in FIG. 4B. For example, the metadata string entry described above related to moods.happiness.type_mouth.overlay=myserver/folder1/hmouth.jpg may provide a location external to service 325 from which to fetch a decal (jpg picture) named “hmouth” to overlay on top of the straight-line mouth. The smiling mouth (or any other overlay) may further be provided by a user, or may be automatically generated by manipulating the existing baseline image using photo editing software. It is understood that alternate dispositions may be implemented, such as sadness, anger, tongue-sticking-out and the like based at least in part on selections similar to those shown in FIG. 4B.

As another example of contextual modification, a user may be listening to streaming music from a service. The music may be provided by the same service that the user has a profile with. Alternatively, the music may be provided by a separate, third-party service, and the details of the music (such as filename, format, and the like) may be transferred to the service containing the profile. Based at least in part on the type of music being listened to, a mood setting may be changed. For example, if the music genre is “pop,” the mood could indicate “happiness” and a profile image may be changed accordingly. In addition, there may be background music (e.g., streaming music) associated with a user's homepage, profile page or the like, and based on a context, the music may be changed. For instance, if the user's favorite sports team has won, songs associated with victory and/or the sports team may be played. A user may specify the association between the music selections and the teams, or the association may be established by other users, the team, or the service. For example, Arsenal-related songs, such as Good ol' Arsenal, could be played when the Arsenal football (soccer) team has won.

Thus, in view of the foregoing example, streaming music received from a separate, third-party service may serve to modify a baseline version of an image in addition to, or as a substitute for, metadata (directly) associated with image. Both the music and the metadata may generally be referred to as data.

In FIG. 5C, the user of PC 315 may indicate via a user profile setting that he is out of the office and on vacation in Costa Rica. Thus, relative to FIGS. 5A and 5B, in FIG. 5C person 505 has now both a smiling mouth and sunglasses on. Again the change may have been brought about as a result of a metadata string entry or the like being triggered responsive to the change in the user profile setting. It is understood that coordinates may be used in a manner similar to the (x,y) pair used to represent the mouth to facilitate the addition of the sunglasses in FIG. 5C. For example, the depicted person's right eye may be located at coordinates (25,50) and the depicted person's left eye may be located at coordinates (35,50) based at least in part on the selections shown in FIG. 4B for “location1” and “location2,” respectively. Furthermore, it is understood that additional features may be implemented. For example, if the user indicated that he was on vacation in Alaska (as opposed to Costa Rica) a scarf may have been overlayed on top of person 505's neck instead of overlaying a pair of sunglasses on top of person 505's eyes.

An image uploaded to service 325 may contain location information where the image was taken, or the location information could be separately uploaded. An image uploaded to a service may, by default, have some categories that could be affected by the contextual modification, such that a user might not need to manually define the triggering-condition(s) that cause contextual modification. For example, the image may include status, location, time, or other attributes that, when the related context changes, may cause the image to be modified. Thus, when a location of a user's device changes (e.g., as determined by GPS module 245 of FIG. 2), the part of the image sensitive to a change in location may undergo contextual modification.

In FIG. 5D, service 325 may implement a theme such as “silly moustache week” such that person 505 now appears in a profile image with a silly moustache relative to FIG. 5A for an entire week. A field or flag associated with the metadata may indicate whether the user wants to partake in themes sponsored by service 325. For example, a user might not want to partake in “silly moustache week” and may opt out or opt in regarding participation in the theme.

In FIG. 5E, person 505 is shown with a cat-head on his shirt. The cat-head may be a logo of the user's favorite sports team (e.g., the Chicago Cats) and may be overlaid on top of the person's clothing according to predefined criteria, e.g., the user selecting the logo, the Chicago Cats playing a game at the time the image is being viewed, the Chicago Cats winning a playoff game, or some other specified criteria. Again, metadata associated with the image may facilitate the addition or removal of the team logo. Other scenarios are possible. For example, during the week of a political election, a pin or indicia emblematic of a supported candidate may be placed on the user's clothing, or the background of the image may reflect a political image, e.g., of the White House in Washington, D.C., such that the image has the appearance that person 505 is standing in front of the White House.

The description provided above allows for contextual image modification. For example, if images are used in social networking applications, mobile applications, and the like, normally-static images may be used to convey information about a user or a user device's context. In relation to FIGS. 5A and 5C, for example, the change from a straight-line mouth to a smiling mouth and the addition of sunglasses may be based at least in part on determining that the user's mobile device is located in Costa Rica. Thus, a global positioning system (GPS) may be used to determine a user's mobile device location and the appearance of person 505 in the image 501, or the background of image 501, may be updated responsive to the GPS location or city, e.g., based at least in part on weather at the current location, an event at the current location, a popular attraction at the current location, or based at least in part on some other relationship between the user and the current location.

The foregoing description in relation to FIG. 5 was provided with respect to an image of a person. It is understood that the subject matter of the image may be adapted to accommodate various scenarios. For example, a user may initially indicate that he purchased an apple from the store, and responsive thereto an image of a full apple may appear in the user's profile. Thereafter, the user may indicate that he finished eating the apple, and the picture of the apple on the user's profile may be changed or updated to only show a core of an apple.

The contextual modifications provided with the metadata may be triggered based at least in part on any number of criteria, such as a device/user location, calendar information, time and date, other devices nearby the user's device, currently running or installed applications on a device, user preferences or interests, advertisement-based modification of an image, news events (e.g., sports, entertainment, politics, weather, economics/financials, etc.), and so on.

Modification of the image may be performed at service 325. Furthermore, the contextual modifications may be stored at service 325, or may be acquired from a third party (e.g., a third-party website). Alternatively, in some embodiments the contextual modifications may be made at a user device (e.g., PC 315). Irrespective of where the modifications are made, additional users (e.g., users of peer devices 335(1)-335(N)) may be able to view either the baseline version of the image or a contextually modified version of the image. The additional users may be able to view or otherwise access either version of the image based at least in part on one or more permissions.

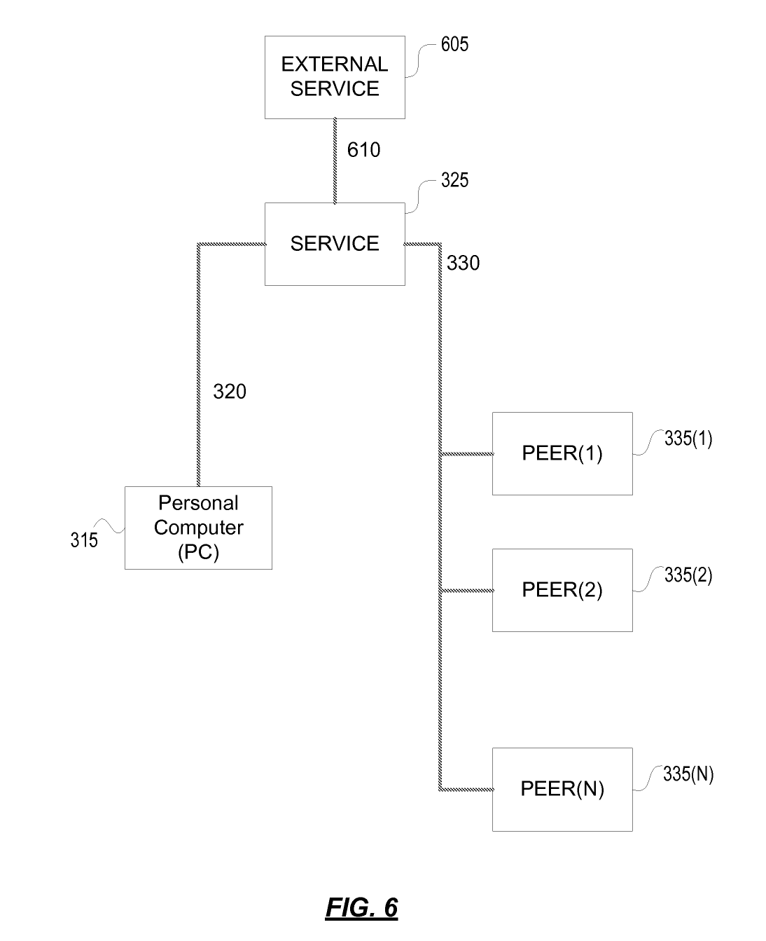

FIG. 6 includes an architecture similar to the one shown in FIG. 3. In FIG. 6, an external service 605 is shown coupled to service 325 by way of a communication link 610. Communication link 610 may support a transfer of data between external service 605 and service 325. External service 605 may be associated with one or more third parties and may provide a triggering-condition for contextually modifying an image uploaded to service 325. External service 605 is merely intended to be representative of an additional service that may be communicatively coupled to service 325. In some embodiments, external service 605 may actually represent multiple services, and one or more of the multiple services may share a communication link (e.g., communication link 610) with service 325, or the multiple services may each have their own communication link with service 325.

As an illustrative example of the use of the architecture of FIG. 6, a user of PC 315 may indicate that she is interested in the Arsenal futbol (soccer) team, e.g., by listing Arsenal in an “interests” section of her profile associated with service 325. Service 325 may request, observe, pull or receive data from external service 605 via communication link 610; the data may be related to Arsenal and may be used to modify an image. For example, Arsenal may have played a game and won. Service 325 may receive an indication of Arsenal's victory, or may observe a web site where game/match results are listed. Service 325 may modify an image of the user uploaded to service 325 to show the user as having a happy face. The user (by way of PC 315) or service 325 may indicate the positions of the image that may be automatically and/or manually affected or modified by data obtained/received from external service 605. For example, pixels, or coordinates, of the image could be marked that may be changed based at least in part on the contextual information change obtained from external service 605.

In some embodiments, the additional users may be able to effectuate contextual modifications based at least in part on one or more permissions having been granted to the additional users e.g., by PC 315 or service 325. For example, the one or more permissions may be specified in metadata submitted by PC 315 to service 325. The additional users may generate metadata in a manner similar to the generation of the metadata string by PC 315 described above with respect to FIG. 4B. Upon receipt of the metadata string from an additional user, service 325 may compare an identity of the additional user (the additional user's identity may be included in metadata submitted by the additional user to service 325) to a listing of additional user identities submitted by PC 315 to determine whether the additional user has been granted permission to effectuate contextual modification. If the comparison yields a match, service 325 may save the metadata submitted by the additional user. The permissions submitted by PC 315 may also dictate access rights, or that is to say, some additional users might only be able to view the baseline version of the image, whereas other additional users might have permission to view the contextually modified version(s) of the baseline image.

Based on the foregoing description, a user may upload a baseline version of an image to a service. The user may also define a set of metadata to be associated with the (baseline version of the) image. The metadata may be generated via a user-friendly menu interface, the metadata may be generated by the user via one or more computer programming languages (e.g., C, C++, Java, and the like), or other such metadata generation technique. Thereafter, users of peer devices may be able to view the baseline version of the image, or may view the baseline version of the image overlaid by modifications (e.g., decals) responsive to one or more triggering conditions having been satisfied with respect to the metadata.

In some embodiments, a service (e.g., service 325 of FIG. 3) may perform an analysis and associate metadata with the uploaded, baseline version of the image. The service may make selections based at least in part on past trends or preferences associated with a user profile. For example, if the user has historically expressed an interest in sports, the service may attempt to provide metadata that is triggered whenever noteworthy sporting events take place. The service may use image editing software to analyze the baseline image, automatically generate overlays for one or more contextual modification (e.g., happiness), automatically generate background overlays for the baselines image (e.g., automatically detect the user in the image, and determine the background area which must be overwritten by a new background such as a beach), etc.

Based on the foregoing description, content-rich images may be obtained without requiring a need to store or save variations of a baseline version of an image. Instead, content-rich images may be obtained simply by imposing modifications to a single baseline image. As such, significant storage capacity may be saved because the apparatuses, methods, and systems described herein promote reuse of image resources. Moreover, based on the instant disclosure, user profiles and the like have a tendency to “come to life” and may convey a greater degree of information than was previously possible. As the old saying goes, “sometimes a picture is worth more than one-thousand words.”

The foregoing description was provided in relation to the sharing and distribution of images. It is understood that the techniques may be extended to encompass any type of content object. For example, a textual web blog may be updated to convey information based at least in part on a user location. More specifically, if a user is located near Keystone, South Dakota, his blog may be updated to contain a description of Mount Rushmore. The description of Mount Rushmore may be taken from a document library, another user's profile, or the like. Thereafter, if the user travels from South Dakota to San Francisco, Calif., the textual description of Mount Rushmore on his blog may be replaced by a description of the Golden Gate Bridge.

Similarly, a baseline audio might play back a sound-recorded message such as “the doctor is in” stored in an audio file, e.g., “status.wav.” A metadata entry similar to that shown and described above with respect to FIG. 4B may enable the doctor, when leaving the office for the day, to switch the message over to “the doctor is out” by simply replacing the term “in” with “out.” That is, when the doctor changes his or her profile to indicate the doctor has left the office, the metadata might indicate that an audio file (e.g., “out.wav”) that only speaks the word “out” should be played over the audio file “status.wav” at an appropriate time after initiating playback of the baseline audio file, e.g., at 1.3 sec., thereby causing a user to hear “the doctor is out” instead of “the doctor is in.” In this manner, less storage is consumed because the introductory language “the doctor is” may be used for both types of messages, and hence, does not need to be stored twice. Additionally, the doctor may associate music from a third party service with the change in profile, such that a different song is played when the doctor is “in” relative to when the doctor is “out.”

In the context of video, movie directors and screen writers frequently engage in an editing process when formulating a final version of a movie. The editing process may entail deleting scenes, adding scenes and substituting scenes. Metadata similar to that described above with respect to FIG. 4B may improve the management of the editing process by allowing the director or screen writer to incorporate scenes based at least in part on selections made in accordance with a menu similar to that shown in FIG. 4B. The metadata as described above may also be used to define individualized videos or movies for users based at least in part on user profiles, preferences, and the like, creating a unique video experience for each user based at least in part on the user profile or user actions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a baseline content object from a computing device;
identifying data associated with the baseline content object; and
contextually modifying the baseline content object responsive to determining that a triggering condition occurs, the triggering condition being determined based at least in part on the data.

2. The method of claim 1, further comprising:
communicating the contextually modified content object to a second device.

3. The method of claim 1, further comprising:
communicating the baseline content object and the data to a device.

4. The method of claim 1, further comprising:
determining that the data includes a permission for a device to contextually modify the baseline content object;
receiving second data associated with the baseline content object from the device; and
contextually modifying the baseline content object responsive to determining that a second triggering condition occurs, the second triggering condition being determined based at least in part on the second data.

5. The method of claim 4, further comprising:
resolving a conflict between the data and the second data received from the device.

6. The method of claim 1, wherein the triggering condition is based at least in part on a change in a profile status.

7. The method of claim 1, wherein the triggering condition is based at least in part on a location of the computing device.

8. The method of claim 1, wherein the baseline content object is a baseline image, and wherein the data defines at least one image layer to display with the baseline image at one or more locations specified in the data.

9. The method of claim 1, wherein the baseline content object is a baseline audio file, and wherein the data defines at least one audio layer to overlay on top of the baseline audio file at one or more temporal locations specified in the data.

10. The method of claim 1, wherein the baseline content object is a baseline video file, and wherein the data defines at least one video layer to display with the baseline video file at one or more temporal locations specified in the data.

11. The method of claim 1, wherein the data specifies a location from which to fetch an item to impose on the baseline content object.

12. An apparatus comprising:
a processor; and
a memory having stored thereon computer-executable instructions that, when executed by the processor, cause the apparatus to perform:
receiving a baseline content object from a computing device;
identifying data associated with the baseline content object; and
contextually modifying the baseline content object responsive to determining that a triggering condition occurs, the triggering condition being determined based at least in part on the data.

13. The apparatus of claim 12, wherein the computer-executable instructions include at least one instruction that, when executed, causes the apparatus to perform:
communicating the contextually modified content object to a device.

14. The apparatus of claim 12, wherein the computer-executable instructions include at least one instruction that, when executed, causes the apparatus to perform:
communicating the baseline content object and the data to a device.

15. The apparatus of claim 12, wherein the computer-executable instructions include at least one instruction that, when executed, causes the apparatus to perform:
determining that the data includes a permission for a device to contextually modify the baseline content object;
receiving second data associated with the baseline content object from the device; and
contextually modifying the baseline content object responsive to determining that a second triggering condition occurs, the second triggering condition being determined based at least in part on the second data.

16. The apparatus of claim 15, wherein the computer-executable instructions include at least one instruction that, when executed, causes the apparatus to perform:
resolving a conflict between the data and the second data received from the device.

17. The apparatus of claim 12, wherein the triggering condition is based at least in part on a change in a profile status.

18. The apparatus of claim 12, wherein the triggering condition is based at least in part on a location of the computing device.

19. The apparatus of claim 12, wherein the baseline content object is a baseline image, and wherein the data defines at least one image layer to display with the baseline image at one or more locations specified in the data.

20. The apparatus of claim 12, wherein the baseline content object is a baseline audio file, and wherein the data defines at least one audio layer to overlay on top of the baseline audio file at one or more temporal locations specified in the data.

21. The apparatus of claim 12, wherein the baseline content object is a baseline video file, and wherein the data defines at least one video layer to display with the baseline video file at one or more temporal locations specified in the data.

22. The apparatus of claim 12, wherein the data specifies a location from which to fetch an item to impose on the baseline content object.

23. A computer readable storage medium having stored thereon computer-executable instructions that, when executed, perform:
receiving a baseline content object from a computing device;
identifying data associated with the baseline content object; and
contextually modifying the baseline content object responsive to determining that a triggering condition occurs, the triggering condition being determined based at least in part on the data.

24. The computer readable storage medium of claim 23, wherein the computer-executable instructions include at least one instruction that, when executed, performs:
communicating the contextually modified content object to a device.

25. The computer readable storage medium of claim 23, wherein the computer-executable instructions include at least one instruction that, when executed, performs:
communicating the baseline content object and the data to a device.

26. The computer readable storage medium of claim 23, wherein the baseline content object is a baseline image, and wherein the data defines at least one image layer to display with the baseline image at one or more locations specified in the data.

27. The computer readable storage medium of claim 23, wherein the computer-executable instructions include at least one instruction that, when executed, performs:
determining that the data includes an indication that contextual modification is enabled,
wherein the contextual modification of the baseline content object is based at least in part on the determination that the data includes the indication that contextual modification is enabled.

28. A method comprising:
transmitting a baseline content object to a service; and
identifying data associated with the baseline content object, the data contextually modifying the baseline content object responsive to a triggering condition.

29. The method of claim 28, further comprising:
granting a permission to at least one device, the permission including at least one of: allowing the at least one device to access the baseline content object and allowing the at least one device to access a contextually modified version of the baseline content object.

30. The method of claim 28, wherein the baseline content object is a baseline image, and wherein the data defines at least one image layer to impose on the baseline image at one or more locations specified in the data.

31. An apparatus comprising:
a processor; and
a memory having stored thereon computer-executable instructions that, when executed by the processor, cause the apparatus to perform:
transmitting a baseline content object to a service; and
identifying data associated with the baseline content object, the data contextually modifying the baseline content object responsive to a triggering condition.

32. The apparatus of claim 31, wherein the baseline content object is a baseline image, and wherein the data defines at least one image layer to impose on the baseline image at one or more locations specified in the data.

33. A computer readable storage medium having stored thereon computer-executable instructions that, when executed, perform:
transmitting a baseline content object to a service; and
identifying data associated with the baseline content object, the data contextually modifying the baseline content object responsive to a triggering condition.

34. The computer readable storage medium of claim 33, wherein the computer-executable instructions include at least one instruction that, when executed, performs:
receiving an input, the input defining the triggering condition; and
generating the data based at least in part on the received input.

35. A method comprising:
generating data associated with a baseline content object;
determining that a triggering condition occurs;
generating a contextually modified version of the baseline content object based at least in part on a portion of the data that is responsive to the triggering condition; and
transmitting the contextually modified version of the baseline content object to a service.

36. The method of claim 35, wherein the baseline content object is a baseline image, and wherein the data defines at least one image layer to display with the baseline image at one or more locations specified in the data.

37. The method of claim 35, wherein the baseline content object is a baseline audio file, and wherein the data defines at least one audio layer to impose on the baseline audio file at one or more temporal locations specified in the data.

38. The method of claim 35, wherein the baseline content object is a baseline video file, and wherein the data defines at least one video layer to display with the baseline video file at one or more temporal locations specified in the data.

39. A computer readable storage medium having stored thereon a data structure, comprising:
a first field identifying a baseline content object;
a second field identifying a triggering condition;
a third field identifying an item to be overlaid on top of the baseline content object when the triggering condition is met; and
a fourth field specifying a location in the baseline content object where the item is to be overlaid when the triggering condition is met.

40. The computer readable storage medium of claim 39, wherein the baseline content object is an image, and wherein the triggering condition is based at least in part on a news event.
